(19) United States
(12) Patent Application Publication
(10) Pub. No.: US 2015/0050009 A1
(43) Pub. Date: Feb. 19, 2015

(54) TEXTURE-BASED ONLINE MULTIMEDIA EDITING

(71) Applicant: WEVIDEO, INC., MOUNTAIN VIEW, CA (US)

(72) Inventors: Jostein Svendsen, Saratoga, CA (US); Bjørn Rustberggaard, Nesoya (NO); Krishna Menon, Saratoga, CA (US)

(73) Assignee: WEVIDEO, INC., Mountain View, CA (US)

(21) Appl. No.: 14/181,507

(22) Filed: Feb. 14, 2014

Related U.S. Application Data
(60) Provisional application No. 61/865,555, filed on Aug. 13, 2013.

(51) Int. Cl. G11B 27/036

(52) U.S. Cl. CPC G11B 27/036
USPC 386/280

(57) ABSTRACT

Systems and methods described herein relate to creating or modifying multimedia content using sprites. In accordance with some implementations, a method can comprise the operations of: accessing foundational content; receiving a request to apply a sprite effect from a sprite sheet to the foundational content; retrieving the sprite effect from the sprite sheet; and applying the sprite effect to the foundational content according to the request. A sprite sheet can include two or more sprites each of which can be used as an effect in multimedia content, and each of which can be retrieved from the sprite sheet based on coordinates in the sprite sheet. A sprite effect can be an image, an animation, or some other visual-based effect applicable to multimedia content.

### CROSS-REFERENCE TO RELATED APPLICATIONS

This application claims priority to U.S. Provisional No. 61/865,555, filed Aug. 13, 2013, entitled “TEXTURE-BASED ONLINE MULTIMEDIA EDITING, which is incorporated herein by reference.

### BACKGROUND

With conventional editing equipment, creative professionals use physical media to capture specific scenes and manually add soundtracks, video clips, and special effects to incorporate creative elements like story elements, plots, characters, and thematic elements. The process provides a classical touch and feel that aligned with the creative energies of film producers, directors, screenwriters, and editors. However, the process can be expensive, time-consuming and complicated, sometimes requiring access to editing equipment typically located in film studios.

Locally installed film editing systems, such as standalone computer programs, allow users to edit digital multimedia using locally stored special effects, including those relating to audio or video overlays. However, locally installed film editing systems often require users to purchase special effects packages, limiting a user to the editing effects locally installed on his or her computer. Additionally, depending on the content being edited or effects involved the application of effects, particularly visual effects can be computationally intensive and/or can require specialized computer hardware. As such, locally installed film editing systems are often times are limited to computing devices with higher processing power than typically found on cheaper or smaller computing devices.

To permit users access to professional quality film editing systems, some provide online multimedia editing systems that are implemented on one or more networked computer systems (e.g., servers or cloud-based resources) capable of handling higher quality multimedia editing, and that are accessible by various a user computing devices over a local or wide-area network, such as the Internet. In this way, various types of user computing device, including smart phones, are capable of using higher-quality multimedia editing systems even when a given type of user computing device lacks the ability to perform higher-quality multimedia content editing on its own. Generally, as a user edits multimedia content using such online multimedia systems from their user computing device, the results of the edits are rendered at the network computer systems and a preview of the lower-quality rendering of the content can be provided to the user computing device (e.g., before a final, higher-quality version of the content is provided) to save on network bandwidth.

The foregoing examples of film editing systems are intended to be illustrative and not exclusive. Other limitations of the art will become apparent to those of skill in the relevant art upon a reading of the specification and a study of the drawings.

### SUMMARY

The present application discloses systems and methods of creating or modifying multimedia content (e.g., video or audio content) using one or more sprites from a sprite sheet. As used herein, “sprite-based content editing” will be understood to include creating or modifying multimedia content that involves one or more sprites from a sprite sheet. The sprite sheet used during sprite-based content editing can include two or more sprites, each of which can be used as an effect that enhances or otherwise modifies multimedia content. Herein, a “sprite effect” or a “sprite-based effect” can refer to any type of sprite that can be retrieved from a sprite sheet and applied to multimedia content as an effect. Additionally, a sprite effect can include an image, an animation, or some other image effect applicable to multimedia content. In various implementations, a sprite effect can be retrieved from the sprite sheet based on coordinates relative to the sprite sheet. Though various implementations disclosed herein are described in contexts involving “effects,” it should be understood that such contexts can also involve sprite effects when applicable.

Through use of sprite effects and sprite sheets, various implementations can improve the speed and/or efficiency with which effects are applied to multimedia content. When applying particular effects to multimedia content, a system or method can leverage various graphics application program interfaces (APIs) that may be, at least in part, optimized to use sprites and sprite sheets and apply sprites to multimedia content. An example of a graphics API used by some implementations includes OpenGL, which has various library functions adapted for application use of sprites and sprite sheets.

In some implementations, where a multimedia editing system comprises of a client communicatively coupled to a server that performs multimedia editing operations on behalf of the client (e.g., an online content multimedia contenting editing system), it will be understood that sprite effects and sprite sheets can be utilized at either the client, the server, or at both. For certain implementations, the use of sprite effects and sprite sheets can improve or otherwise facilitate online content editing in systems where servers perform multimedia content editing and produce high quality multimedia content on behalf of clients (e.g., based on a client request). For example, while a server performs higher-quality, effects-based enhancements to multimedia content targeted for enhancement (also referred to as “foundational content”) on behalf of a client (e.g., based on a client's request), the client can utilize sprite-based effects, from a sprite sheet, to locally generate preview content that corresponds to the enhanced multimedia content that results at the server.

In some such implementations, the use of sprite effects and sprite sheets can improve or otherwise enable a client's ability to locally generate and provide a local preview of the higher-quality multimedia content being produced at a server. For example, clients to use the sprite effects and sprite sheet to locally generate previews of effects-based content operations (e.g., previews of content enhancements resulting at a server) that the client would otherwise not be able to be generate or would generate with little or no improvement over a server generating and providing such previews to the client.

According to various implementations, a client can locally generate such preview content by: (a) retrieving, from one or more sprite sheets, sprite effects that correspond to one or more effects being applied by a server to foundational content on behalf of the client; and (b) applying those retrieved sprite effects to a local version of the foundational content that is being enhanced by the server. For some implementations, the client may or may not receive sprite sheets, containing relevant sprite effects, from the server before, during or after the server has applied effects, corresponding to those sprite effects, to the foundational content. For some implementations, a sprite sheet provided by the server to the client can be one that is pre-generated and stored at the server, one that is generated based on a set of effects being applied by the server to the foundational content on behalf of the client (e.g., where the sprite effects correspond to the set of effects being applied), or some combination thereof (e.g., a pre-generated sprite sheet that is augmented by the server with additional sprite effects corresponding to effects being applied by the server).

### BRIEF DESCRIPTION OF THE DRAWINGS

FIG. 1 depicts a diagram of an example of a system for sprite-based content editing in accordance with various implementations.

FIG. 2 depicts a diagram of an example of a system for sprite-based content editing in accordance with some implementations.

FIG. 3 depicts a diagram illustrating an example of a sprite sheet and an example of applying of a sprite effect to multimedia content in accordance with some implementations.

FIG. 4 depicts a flowchart of an example of a method for sprite-based content editing in accordance with some implementations.

FIG. 5 depicts an example of a client-side user interface for sprite-based content editing in accordance with some implementations.

FIG. 6 depicts an example of a system on which techniques described herein can be implemented.

### DETAILED DESCRIPTION

This paper describes techniques that those of skill in the relevant art can implement in numerous ways. For instance, those of skill in the relevant art can implement the techniques described herein using a process, an apparatus, a system, a composition of matter, a computer program product embodied on a computer-readable storage medium, and/or a processor, such as a processor configured to execute instructions stored on and/or provided by a memory coupled to the processor. Unless stated otherwise, a component such as a processor or a memory described as being configured to perform a task may be implemented as a general component that is configured to perform the task at a given time or a specific component that is manufactured to perform the task. As used herein, the term ‘processor’ refers to one or more devices, circuits, and/or processing cores configured to process data, such as computer program instructions.

A detailed description of one or more implementations of the invention is provided below along with accompanying figures that illustrate the principles of the invention. The invention is described in connection with such implementations, but the invention is not limited to any implementation. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

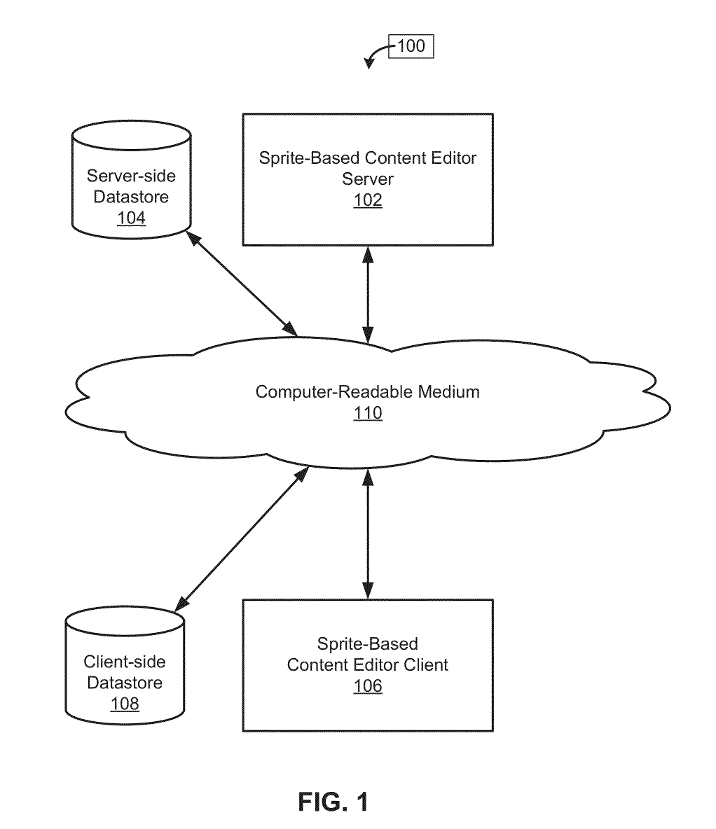

FIG. 1 depicts a diagram 100 of an example of a system for sprite-based content editing in accordance with various implementations. In the example of FIG. 1, the system can include a sprite-based content editor server 102, a server-side datastore 104, a sprite-based content editor client 106, and a client-side datastore 108, each of which is communicatively coupled through a computer-readable medium 110.

As used in this paper, the term “computer-readable medium” is intended to include only physical media, such as a network, memory or a computer bus. Accordingly, in some implementations, the computer-readable medium can permit two or more computer-based components to communicate with each other. For example, as shown in FIG. 1, the computer-readable medium 110 can be a network, which can couple together the sprite-based content editor server 102 and the sprite-based content editor client 106. Accordingly, for some implementations, the computer-readable medium 110 can facilitate data communication between the sprite-based content editor server 102 and the sprite-based content editor client 106. Though FIG. 1 depicts a single content editor client, the system of FIG. 1 can include multiple content editor clients that can communicate with the sprite-based content editor server 102.

As a network, the computer-readable medium 110 can be practically any type of communications network, such as the Internet or an infrastructure network. The term “Internet” as used in this paper refers to a network of networks that use certain protocols, such as the TCP/IP protocol, and possibly other protocols, such as the hypertext transfer protocol (HTTP) for hypertext markup language (HTML) documents that make up the World Wide Web (“the web”). For example, the computer-readable medium 110 can include one or more wide area networks (WANs), metropolitan area networks (MANs), campus area networks (CANs), or local area networks (LANs); theoretically, the computer-readable medium 110 could be a network of any size or characterized in some other fashion. Networks can include enterprise private networks and virtual private networks (collectively, “private networks”). As the name suggests, private networks are under the control of a single entity. Private networks can include a head office and optional regional offices (collectively, “offices”). Many offices enable remote users to connect to the private network offices via some other network, such as the Internet. The example of FIG. 1 is intended to illustrate a computer-readable medium 110 that may or may not include more than one private network.

As used in this paper, a computer-readable medium is intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware.

Through the arrangement of the system of FIG. 1, the sprite-based content editor client 106 can leverage the computing resources and power of the sprite-based content editor server 102 when creating or modifying elements of foundational content using effects, especially when creating and modifying foundational content at a quality level not capable by the computing resources locally available to the sprite-based content editor client 106. For example, the sprite-based content editor client 106 can request the sprite-based content editor server 102 to perform, on behalf of the sprite-based content editor client 106, content creation and modification operations relating to higher quality (e.g., professional or production quality) foundational content and/or using higher quality effects than possible by the sprite-based content editor client 106. In some implementations, the sprite-based content editor server 102 comprises computing resources that surpass those of the sprite-based content editor client 106, or computing resources that are better suited for content creation or modification of foundational content, using effects, and/or rendering consumable content products at a higher quality than possible than the sprite-based content editor client 106.

As described herein, the sprite-based content editor server 102, the sprite-based content editor client 106, or both can use one or more sprite effects, from a sprite sheet, when creating or modify foundational content. while a server performs higher-quality, effects-based enhancements to multimedia content targeted for enhancement (also referred to as “foundational content”) on behalf of a client (e.g., based on a client's request), the client can utilize sprite-based effects, from a sprite sheet, to locally generate preview content that corresponds to the enhanced multimedia content that results at the server.

For example, while the sprite-based content editor server 102 performs higher-quality, effects-based enhancements to foundational content on behalf of the sprite-based content editor client 106 (e.g., based on the client's request), the sprite-based content editor client 106 can utilize sprite-based effects, from a sprite sheet, to locally generate preview content that corresponds to the enhanced multimedia content that results at the sprite-based content editor server 102. In this way, the sprite-based content editor client 106 can use sprite effects and sprite sheets to locally generate previews of effects-based content operations (e.g., previews of content enhancements resulting at the sprite-based content editor server 102) that the sprite-based content editor client 106 would otherwise (a) not be able to generate or (b) generate with little or no improvement over the sprite-based content editor server 102 generating and providing with such previews to the sprite-based content editor client 106.

In operation, when the sprite-based content editor client 106 is locally generating previews corresponding to the foundational content being created/modified at the sprite-based content editor server 102, the sprite-based content editor client 106 may or may not generate the previews before, after, or concurrently with creation/modification operations being performed by the sprite-based content editor server 102 on the foundation content. For instance, the sprite-based content editor client 106 can locally generate a preview by applying a sprite effect to a local version of foundational content before, after, or concurrently with the sprite-based content editor server 102 applying a corresponding effect to a server-local version of the foundational content. Accordingly, in some implementations, the sprite-based content editor client 106 can locally apply sprite effects to a local version of foundational content as the sprite-based content editor client 106 as the client 106 locally receives instructions from a user and/or as the sprite-based content editor client 106 instructs the sprite-based content editor server 102 to apply corresponding effects at the server 102.

Depending on the embodiment, the sprite sheet utilized by the sprite-based content editor client 106 may be provided to the sprite-based content editor server 102. The sprite-based content editor server 102 can, for example, provide the sprite sheet to the sprite-based content editor client 106 when the sprite-based content editor server 102 is instructed to apply an effect to foundational content (e.g., at the request of the sprite-based content editor client 106) and the sprite sheet provided contains a sprite effect that corresponds to the effect applied. Additionally, depending on the implementation, effects used by the sprite-based content editor server 102 can be at a quality that is similar to or higher than that of sprite effects used and/or applied by the sprite-based content editor client 106 locally. For instance, while the sprite-based content editor server 102 is applying an effect A to foundational content at the request of the sprite-based content editor client 106, the sprite-based content editor server 102 can locally apply a corresponding sprite effect from a local sprite sheet to a local version (e.g., copy) of the foundational content.

In some implementations, the effects applied by the sprite-based content editor server 102 can be by way of sprite effects and sprite sheets, where the sprite effects utilized by the sprite-based content editor server are of a higher quality than the sprite effects utilized by the sprite-based content editor client 106. By doing so, the sprite-based content editor server 102 can perform content creation or modification operations leveraging various graphics application program interfaces (APIs), such as OpenGL, that are configured to use sprites and sprite sheets and apply sprites to multimedia content.

“Foundational content” includes multimedia-based content, whether audio, visual, or audio-visual, that a user enhances using an effect, such as a sprite-based effect, as described in this paper. The multimedia-based content may be authored or otherwise produced by a user using the content creation/editing tool. Foundational content can include content initially based on/started from a vendor-provided or user-provided content. For example, user-provide content used as foundational content can be sourced from a user's personal datastore, such as a memory device coupled to the user's personal computer or integrated in the user's smartphone or camera. Examples of user-provided content (possibly sourced from a personal datastore) can include video recordings of such personal events as weddings, birthday parties, anniversary parties, family vacations, graduations, and those relating to family events (e.g., a child's first steps, a family picnic, a child's recital). In some instances, the foundational content is generated, by a user, using a selection of content segments sourced from user-provided content and/or vendor-provide content. Accordingly, the foundational content can comprise a composition of content portion originating from multiple sources. Accordingly, an example foundational content can comprise a sequence of video clips provided by a user. The foundational content may or may not be one composed by the user to tell a particular story, often one relating to a particular event or occasion (e.g., tells of a personal accomplishment or journey).

The foundational content can be created to be multi-layered content, comprising multiple content layers of different content types include, for example, audio, video, still images/graphics, animation, transition, or other content generated by a content generator. A content generator is typically an individual, but can also be a group, a business entity, or other entity, that creates content using a device like a camera, a video camera, an electronic device (such as a mobile phone or other electronic device), or other device. In some implementations, the content generator's device can comprise an electronic scanner used to capture a painting or drawing. The content generator's device can also include an electronic device that captures content using an input device (e.g., a computer that captures a user's gestures with a mouse or touch screen). High definition/quality content as used herein includes content having definition or quality that is higher than the average definition or quality for the similar content. For example, high definition/quality audio content can include audio clips having a high sampling rate (e.g., 44 KHz), has a higher bit-rate or effective bit-rate (e.g., 256 Kbs), or is encoded in a lossless audio encoding format.

As described herein, the system of FIG. 1 can enable a user at the sprite-based content editor client 106 to instruct the sprite-based content editor server 102 to apply an effect to the foundational content, and to possibly create or modify foundational content, on behalf of the client 106. As noted, the foundational content can be multi-layered content comprising a plurality of content layers, where each content layer comprises one or more content items from a content library, and the content items are provided by a third-party vendor or the user of the sprite-based content editor client 106. In various implementations, the user is presented with a selection of effects via the sprite-based content editor client 106 and the user can select from that one or more effects for application to the foundational content. To facilitate generating a preview of the foundational content resulting at the sprite-based content editor server 102 on behalf of the sprite-based content editor client 106, in some implementations, the sprite-based content editor server 102 can generate a preview version of the resulting foundational content, where the preview version is of a quality lower than the original version of the resulting foundational content. Additionally, or alternatively, some implementations can facilitate generating a preview version of the foundational content that results at the sprite-based content editor server 102, the sprite-based content editor client 106 can apply sprite effects, from a sprite sheet, to a local version of the foundational content, where the sprite effects applied correspond to effects being applied at the sprite-based content editor server 102.

After an effect is applied to the foundational content at the sprite-based content editor server 102, the resulting foundational content can be rendered to a rendered content product, which is be ready for consumption by others. Additionally, in some implementations, consumption (e.g., playback) of the resulting foundational content may or may not be limited to the system of FIG. 1, whereas the rendered content product is consumable by stand-alone media players external to the system.

As described herein, use of sprite effects and sprite sheets can enable the sprite-based content editor client 106 to locally generate previews of foundational content being produced by the sprite-based content editor server 102, and avoid the need for the sprite-based content editor server 102 to prepare and provide such a preview to the sprite-based content editor client 106. This can reduce data communication from the sprite-based content editor server 102 and the sprite-based content editor client 106. This can also improve the time between the sprite-based content editor server 102 applying an effect to foundational content at the sprite-based content editor server 102 and the sprite-based content editor client 106 locally presenting a preview of the resulting foundational content to a user.

To facilitate the sprite-based content editor client 106 to locally generate a preview for foundational content resulting at the sprite-based content editor server 102, the sprite-based content editor server 102 can prepare a copy of a latest version of the foundational content for the sprite-based content editor client 106. Once prepared by the sprite-based content editor server 102, the copy of the latest version of the foundational content can be maintained by and stored at the sprite-based content editor server 102 (e.g., on the server-side datastore 104) on behalf of the sprite-based content editor client 106. With the copy of the latest version of the foundational content, the sprite-based content editor client 106 can apply a sprite effect and/or modify content elements of the copy, possibly in accordance with effects applications and/or content modifications being performed at the sprite-based content editor server 102. Those skilled in the art will appreciate that in some implementations, the sprite-based content editor client 106 can use sprite effects and sprite sheets to locally create or modify locally stored foundational content irrespective of whether the sprite-based content editor client 106 is communicatively coupled to the sprite-based content editor server 102. For instance, the sprite-based content editor client 106 can utilize sprite effects and sprite sheets to perform content creation and modification operations when the sprite-based content editor client 106 is offline with respect to the sprite-based content editor server 102 and/or when the sprite-based content editor client 106 is operating as a standalone content editor system.

As described herein, the copy of the latest version of the foundational content can be maintained at the server 102 (e.g., on the server-side datastore 104), the client 106 can instruct the server 102 to perform the desired effect-based applications and/or modifications to the copy of the latest version of the foundational content and, subsequently, and possibly provide the copy of the resulting foundational content (e.g., when the sprite-based content editor client 106 is not generating its own local version of the foundational using sprite effects, sprite sheets, and a local copy of the foundational content). In some implementations where the copy of the latest version of the foundational content for the sprite-based content editor client 106 is maintained at the client 106 (e.g., on the client-side datastore 108), the client 106 can directly modify the copy of the latest version of the foundational content, possibly using sprite effects and sprite sheets, and then send the modifications applied to the copy of the latest version of the foundational content to the server 102 (which can update the latest version of the foundational content with the received modification).

With respect to some implementations, the application of a sprite effect or modification to the foundational content by the sprite-based content editor client 106 can include, in addition to content modification operations, such operations as: adjusting copyright use limitations on some or all of the foundational content, locking some or all portions of the foundational content such that some or all of the foundational content is prevented from being modified, adding watermarks to some or all of the foundational content, or tagging objects (e.g., people, places, or things) shown in the foundational content.

As the sprite-based content editor server 102 applies effects, or creates/modifies the foundational content product, the server 102 can provide the sprite-based content editor client 106 with an updated version of the foundational content product. The sprite-based content editor client 106 can use the resulting foundational content product (which may or may not comprise proxy content items) for review or editing purposes using sprite effects as the client 106 continues to apply sprite effects or modify the foundational content.

As the sprite-based content editor server 102 applies effects, or creates/modifies the foundational content product (e.g., in accordance with instructions received from sprite-based content editor client 106), the server 102 can store one or more versions of the foundational content on the server-side datastore 104. When the sprite-based content editor client 106 receives a new or updated version of the foundational content, the client 106 can store these on the client-side datastore 108 before the client 106 directly applies a sprite effect or modifies the new/updated foundational content.

Those skilled in the art will appreciate that for various implementations, when a sprite effect application, content modification, or content update is transferred between the sprite-based content editor server 102 and the sprite-based content editor client 106, such application, modification or update can comprise a list of modification instructions (e.g., including layer identification information, timeline information, content identification information), a copy of the modified content in its entirety, or a copy of the content portions that are modified/updated.

In the example of FIG. 1, the sprite-based content editor server 102 and/or the sprite-based content editor client 106 can include an operating system. An operating system is a set of programs that manage computer hardware resources, and provides common services for application software. The operating system enables an application to run on a computer, whereas only applications that are self-booting can generally run on a computer that does not have an operating system. Operating systems are found in almost any device that includes a computer (e.g., cellular phones, video game consoles, web servers, etc.). Examples of popular modern operating systems are Linux, Android®, iOS®, Mac OS X®, and Microsoft Windows®. Embedded operating systems are designed to operate on small machines like PDAs with less autonomy (Windows® CE and Minix 3 are some examples of embedded operating systems). Operating systems can be distributed, which makes a group of independent computers act in some respects like a single computer. Operating systems often include a kernel, which controls low-level processes that most users cannot see (e.g., how memory is read and written, the order in which processes are executed, how information is received and sent by I/O devices, and devices how to interpret information received from networks). Operating systems often include a user interface that interacts with a user directly to enable control and use of programs. The user interface can be graphical with icons and a desktop or textual with a command line. Application programming interfaces (APIs) provide services and code libraries. Which features are considered part of the operating system is defined differently in various operating systems, but all of the components are treated as part of the operating system in this paper for illustrative convenience.

In the example of FIG. 1, the sprite-based content editor server 102 and/or the sprite-based content editor client 106 can include one or more datastores that hold content, effects (e.g., sprite effects and sprite sheets), and/or other data. A datastore can be implemented, for example, as software embodied in a physical computer-readable medium on a general- or specific-purpose machine, in firmware, in hardware, in a combination thereof, or in an applicable known or convenient device or system. Datastores in this paper are intended to include any organization of data, including tables, comma-separated values (CSV) files, traditional databases (e.g., SQL), or other applicable known or convenient organizational formats. Datastore-associated components, such as database interfaces, can be considered “part of” a datastore, part of some other system component, or a combination thereof, though the physical location and other characteristics of datastore-associated components is not critical for an understanding of the techniques described in this paper.

Datastores can include data structures. As used in this paper, a data structure is associated with a particular way of storing and organizing data in a computer so that it can be used efficiently within a given context. Data structures are generally based on the ability of a computer to fetch and store data at any place in its memory, specified by an address, a bit string that can be itself stored in memory and manipulated by the program. Thus some data structures are based on computing the addresses of data items with arithmetic operations; while other data structures are based on storing addresses of data items within the structure itself. Many data structures use both principles, sometimes combined in non-trivial ways. The implementation of a data structure usually entails writing a set of procedures that create and manipulate instances of that structure.

Various components described herein, such as those of the system of FIG. 1 (e.g., the sprite-based content editor server 102 or the sprite-based content editor client 106) can include one or more engines, which can facilitate the application of effects to foundational content (thereby generating a resulting foundational content). As used in this paper, an engine includes at least two components: 1) a dedicated or shared processor and 2) hardware, firmware, and/or software modules that are executed by the processor. Depending upon implementation-specific or other considerations, an engine can be centralized or its functionality distributed. An engine can include special purpose hardware, firmware, or software embodied in a computer-readable medium for execution by the processor. The processor transforms data into new data using implemented data structures and methods, such as is described with reference to the following figures. As used in this paper, a computer-readable medium is intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware.

In the example of FIG. 1, the sprite-based content editor server 102 and/or the sprite-based content editor client 106 can include one or more computers, each of which can, in general, have an operating system and include datastores and engines. Accordingly, those skilled in the art will appreciate that in some implementations, the system of FIG. 1 can be implemented as software (e.g., a standalone application) operating on a single computer system, or can be implemented as software having various components (e.g., the sprite-based content editor server 102 and the sprite-based content editor client 106) implemented on two or more separate computer systems.

In this example, the server 102 and the client 106 can execute sprite-based content editing services inside a host application (i.e., can execute a browser plug-in in a web browser). The browser plug-in can provide an interface such as a graphical user interface (GUI) for a user to access the content editing services on the sprite-based content editor server 102. The browser plug-in can include a GUI to display effects available for use, content and layers stored on the datastores of the sprite-based content editor server 102 and/or the sprite-based content editor client 106. For instance, the browser plug-in can have display capabilities like the capabilities provided by proprietary commercially available plug-ins like Adobe® Flash Player, QuickTime®, and Microsoft® Silverlight®. The browser plug-in can also include an interface to execute functionalities on the engines in the sprite-based content editor server 102.

In the example of FIG. 1, the sprite-based content editor server 102 and/or the sprite-based content editor client 106 can be compatible with a cloud-based computing system. As used in this paper, a cloud-based computing system is a system that provides computing resources, software, and/or information to client devices by maintaining centralized services and resources that the client devices can access over a communication interface, such as a network. The cloud-based computing system can involve a subscription for services or use a utility pricing model. Users can access the protocols of the cloud-based computing system through a web browser or other container application located on their client device.

In the example of FIG. 1, one or more of the engines in the sprite-based content editor server 102 and/or the sprite-based content editor client 106 can include cloud-based engines. A cloud-based engine is an engine that can run applications and/or functionalities using a cloud-based computing system. All or portions of the applications and/or functionalities can be distributed across multiple computing devices, and need not be restricted to only one computing device. In some implementations, the cloud-based engines can execute functionalities and/or modules that end users access through a web browser or container application without having the functionalities and/or modules installed locally on the end-users' computing devices. In the example of FIG. 1, one or more of the datastores in the sprite-based content editor server 102 can be cloud-based datastores. A cloud-based datastore is a datastore compatible with a cloud-based computing system.

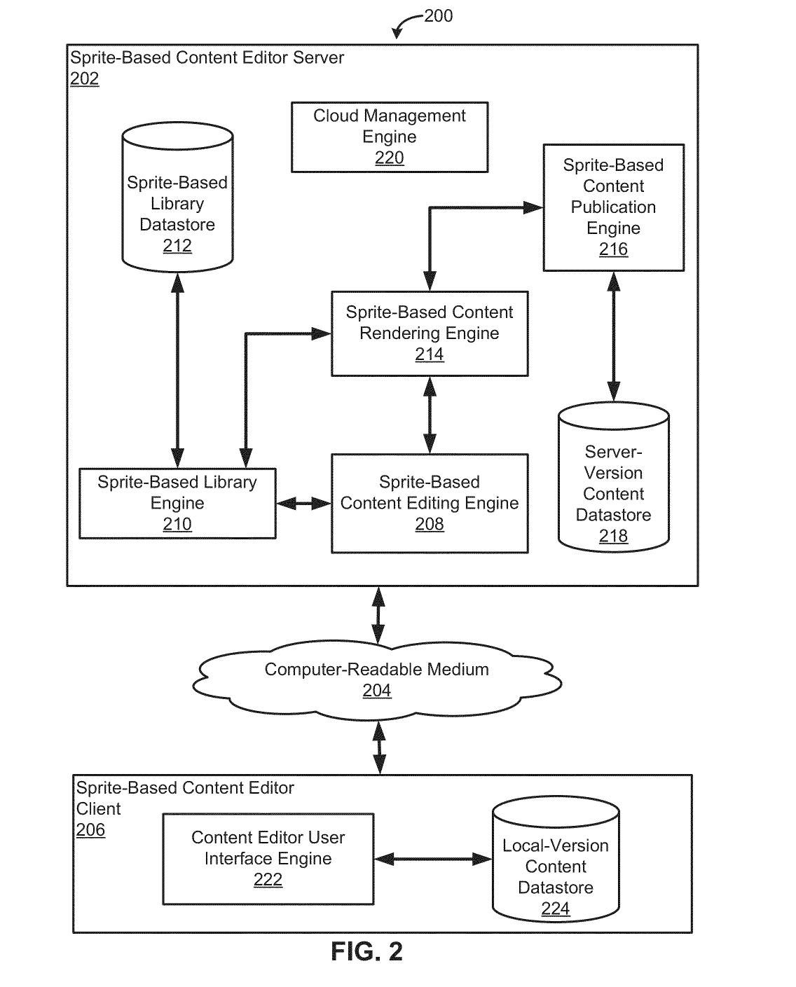

FIG. 2 depicts a diagram 200 of an example of a system for sprite-based content editing in accordance with some implementations. In the example of FIG. 2, the system can include a sprite-based content editor server 202, a sprite-based content editor client 206, a computer-readable medium 204 coupled between the sprite-based content editor server 202 and the sprite-based content editor client 206. For some implementations, the computer-readable medium 204 can be a network, which can facilitate data communication between the sprite-based content editor server 202 and the sprite-based content editor client 206.

In the example of FIG. 2, the sprite-based content editor server 202 can include a sprite-based content editing engine 208, a sprite-based library engine 210, a sprite-based library datastore 212, a sprite-based content rendering engine 214, a sprite-based content publication engine 216, a server-version content datastore 218, and a cloud management engine 220. The sprite-based content editor client 206 can include a content editor user interface engine 222 and a local-version content datastore 224 coupled to the content editor user interface engine 222.

In the example of FIG. 2, the sprite-based content editing engine 208 can be coupled to the sprite-based library engine 210, coupled to the sprite-based content rendering engine 214, and through the computer-readable medium 204, coupled to the content editor user interface engine 222. The sprite-based library engine 210 can be coupled to the sprite-based library datastore 212, coupled to the sprite-based content rendering engine 214, and the sprite-based content editing engine 208. The sprite-based library datastore 212 can be coupled to the sprite-based library engine 210. The sprite-based content rendering engine 214 can be coupled to the sprite-based content editing engine 208, coupled to the sprite-based library engine 210, and coupled to the sprite-based content publication engine 216. The sprite-based content publication engine 216 can be coupled to the sprite-based content rendering engine 214, and coupled to the server-version content datastore 218.

In the example of FIG. 2, the sprite-based content editing engine 208 can execute instructions regarding applying effects (e.g., sprite effects) to or modifying aspects of foundational content a user (e.g., at the sprite-based content editor client 206) intends to enhance or modify. For some implementations, the sprite-based content editing engine 208 can apply effects, such as sprite effects from a sprite sheet, and modify the foundational content by utilizing the functionality of various engines included in the sprite-based content editor server 202, such as the sprite-based library engine 210 and the sprite-based content rendering engine 214. In addition, for some implementations, the sprite-based content editing engine 208 can apply effects and modify the foundational content on behalf of, and in accordance with instructions received from, the sprite-based content editor client 206, and provide the sprite-based content editor client 206 with a copy of the latest version of the foundational content, with which the sprite-based content editor client 206 can locally generate previews (e.g., by applying sprite effects to the copy).

For example, in certain implementations, the sprite-based content editing engine 208 can establish a data connection with the sprite-based content editor client 206 through the computer-readable medium 204 (e.g., a network), can receive commands relating to effect application, content creation or content modification over the data connection (e.g., network connection), can perform effects-based application, content creation or content modification operations in accordance with commands received from the sprite-based content editor client 206, and can transmit to the sprite-based content editor client 206 a version of the foundational content that results from the operations (e.g., resulting foundational content). Depending on the implementation, the commands (relating to application of effects, content creation or content modification) may or may not be generated by the content editor user interface engine 222 residing at the sprite-based content editor client 206. For some implementations, the content editor user interface engine 222 can generate commands as a user at the sprite-based content editor client 206 interacts with a user interface presented by the content editor user interface engine 222. Additionally, as the sprite-based content editor client 106 receives input from the user through the content editor user interface engine 222, the sprite-based content editor client 106 can apply sprite effects to, and thereby generate previews from, a local version of foundational in accordance with the commands the content editor user interface engine 222 generates.

In certain implementations, once an effect (e.g., sprite effect) is selected for application, the sprite-based content editing engine 208 can directly apply the selected effect to the foundational content, or employ the use of the sprite-based content rendering engine 214 to apply the selected effect to the foundational content. In some implementations where the sprite-based content editing engine 208 directly applies the selected effect to the foundational content, the sprite-based content rendering engine 214 can generate the rendered content product from the foundational content as provided by the sprite-based content editing engine 208. Alternatively, in various implementations where the sprite-based content rendering engine 214 can apply the effect to the foundational content on behalf of the sprite-based content editing engine 208 and then provide the resulting foundational content that results to the sprite-based content editing engine 208.

To converse on processing time, processing resources, bandwidth, and the like, the sprite-based content editing engine 208 in certain implementations may or may not utilize lower quality content (e.g., non-high definition video) or sprite-based effects when applying effects, creating content, and/or modifying content with respect to foundational content. The lower quality foundational content that results from use of such lower quality items can be useful for preview purposes, particularly when the foundational content is being actively edited. Eventually, the sprite-based content rendering engine 214 can generate a higher quality version of the foundational content (i.e., the rendered content product) when a user has concluded previewing and/or editing the foundational content.

In some implementations, the sprite-based content editing engine 208 can apply a selected effect (e.g., sprite effect) to foundational content according to one or more licensing parameters associated with the selected effect (e.g., sprite effect or a related sprite sheet), where the licensing parameters define rights and permissions of use for the selected effect. For example, the one or more licensing parameters associated with an effect can comprise a limitation and/or a cost associated with use of the effect. An effect can be one selected for application can include those provided by (e.g., created by) one or more user of the system of FIG. 2 and/or third-party vendors. Depending on the implementation, the author of a given effect and/or operator of the system can define licensing parameters for the effects (e.g., sprite effects and sprite sheets) available for use through the system. For example, an author of a given sprite effector sprite sheet can define licensing parameters that control usage of the sprite effect or the sprite sheet by the sprite-based content editor server 202, the sprite-based content editor client 206, or both. In certain implementations, a sprite effect can adopt some or all of the licensing parameters defined for its corresponding sprite sheet, and/or adopt licensing parameters different from those defined for its corresponding sprite sheet. The licensing parameter(s) for an effect (e.g., a sprite effect from a sprite sheet) can determine and/or limit the licensing parameter(s) of the foundational content that results from application of the effect on the foundational content. Use limitations of an effect as defined by a licensing parameter can include those relating to quality of the effect (e.g., high definition or lower definition sprite-based effects), subject matter of foundational content to be enhanced by the effect, publication options for the foundational content enhanced by the effect, media format of the foundational content enhanced by the effect, and the like. Licensing parameters for a given effect can be provided to the sprite-based content editing engine 208 directly by way of the sprite-based library engine 210, the sprite-based library datastore 212, and/or a separate effects licensing management engine (not shown).

In some implementations, the sprite-based content editor server 202 can include a payment engine (not shown) that facilitates user payment to the system of FIG. 2, and can determine the level of functionality provided by the sprite-based content editor server 202, or the level of definition/quality for sprite-based effects applied to foundational content. For instance, once payment has been received by the payment engine and the payment engine has informed the sprite-based content editing engine 208 of such payment, the sprite-based content editing engine 208 can allow the user to access certain effects or content in the sprite-based library datastore 212 (e.g., sprite effects from a sprite sheet), can allow the user to perform certain content creation, content modification, and/or sprite-related operations, or can allow the user to publish the foundational content with high definition/quality effects. In some implementations, the definition/quality of the effects within the foundational content can be variable and determined based on the amount payment made by the user. The payment engine can maintain an account, the balance from which funds are deducted as payments to the sprite-based content editor server 202 or to which charges are incurred allowing a user to submit payment later (e.g., a credit system). In various implementations, the sprite-based content editing engine 208 can inform the payment engine of the costs accrued by the user as he or she uses effects (e.g., sprite-based effects) from the sprite-based library datastore 212 in the foundational content, or as certain functionality of the sprite-based content editing engine 208 is utilized. The pricing for content items can be stored with the content items in the sprite-based library datastore 212.

The sprite-based content editing engine 208 can receive pre-payment or post-payment through the payment engine to permit access to for-purchase effects, to determine rendering options when generating a rendered content product from the foundational content, and/or to permit publication of the foundational content (e.g., after application of an effect). The system of FIG. 2 can utilize certain payment parameters or conditions, such as amount of payment, success of payment processing, or type of payment, in determining (e.g., limiting) use of select effects. In some implementations, use of an effect based on payment parameters and conditions can be defined at least in part by licensing parameters associated with the effect.

In the example of FIG. 2, the sprite-based library engine 210 can is coupled to the sprite-based library datastore 212 and effects stored therein, which can include sprite effects and related sprite sheets. As discussed herein, the sprite sheet can include two or more sprites, each of which can be used as an effect that enhances or otherwise modifies multimedia content. Herein, a “sprite effect” or a “sprite-based effect” can refer to any type of sprite that can be retrieved from a sprite sheet and applied to multimedia content as an effect. Accordingly, a sprite effect can include an image, an animation, a title, a transition, a lower third, a caption, or some other image effect applicable to multimedia content. In various implementations, a sprite effect can be retrieved for use, from the sprite sheet, based on coordinates relative to the sprite sheet (e.g., X and Y Cartesian coordinates). In some implementations, sprite effects can be stored individually in the sprite-based library datastore 212 and associated with one or more sprite sheets such that the sprite-based content editor server 202 (e.g., the sprite-based library engine 210) can generate sprite sheets as the sprite sheets or related sprite effects are requested for retrieval. Additionally, in some implementations, the sprite effects can be stored as part of sprite sheets that are pre-generated and stored in the sprite-based library datastore 212.

For some implementations, the sprite-based library engine 210 can be responsible for adding, deleting and modifying effects stored on the sprite-based library datastore 212, for retrieving a listing of content items stored on the sprite-based library datastore 212, for providing details regarding effects stored on the sprite-based library datastore 212, and for providing to other engines effects from the sprite-based library datastore 212. For instance, the sprite-based library engine 210 can provide a sprite sheet containing a sprite effect, to the sprite-based content editing engine 208, as a user selects an effect, corresponding to the sprite effect, to be added to the foundational content that the user intends to enhance. In another example, the sprite-based library engine 210 can provide a high quality effect to the sprite-based content rendering engine 214 as the engine 218 renders one or more layers of the foundational content to generate a rendered content product (which may be ready for consumption by others).

In various implementations, the sprite-based library engine 210 can function as a marketplace through which sprite effects and/or sprite sheets can be browsed, purchased, or exchanged. The sprite effects and/or sprite sheets available through the sprite-based library engine 210 can include those made available for free, those available for purchase, those created by users of system of FIG. 2, or created by third-party vendors. The sprite-based library engine 210 can further enable a user of the system to share and/or exchange user-created sprite effects and/or sprite sheets with other users.

In the example of FIG. 2, the sprite-based library datastore 212 can store one or more effects, sprite sheets, and/or sprite effects relating to those sprite sheets. As used herein, the sprite sheet can include two or more sprites, each of which can be used as an effect that enhances or otherwise modifies multimedia content. Herein, a “sprite effect” or a “sprite-based effect” can refer to any type of sprite that can be retrieved from a sprite sheet and applied to multimedia content as an effect. Accordingly, a sprite effect can include an image, an animation, a title, a transition, a lower third, a caption, or some other image effect applicable to multimedia content. In various implementations, a sprite effect can be retrieved from the sprite sheet based on coordinates relative to the sprite sheet. Additionally, in some implementations, sprite effects can be stored individually in the sprite-based library datastore 212 and associated with one or more sprite sheets such that the sprite-based content editor server 202 (e.g., the sprite-based library engine 210) can generate sprite sheets as the sprite sheets or related sprite effects are requested for retrieval. Additionally, in some implementations, the sprite effects can be stored as part of sprite sheets that are pre-generated and stored in the sprite-based library datastore 212.

In some instances, the effect can comprise a piece of multimedia content (e.g., audio, video, or animation clip), which may or not be in a standard multimedia format. For example, a sprite-based audio effect can be embodied in such audio file formats as WAV, AIFF, AU, PCM, MPEG (e.g., MP3), AAC, WMA, and the like. In another example, a video effect can be embodied in such video file formats as AVI, MOV, WMV, MPEG (e.g., MP4), OGG, and the like. In a further example, a sprite image effect can be embodied in such image file formats as BMP, PNG, JPG, TIFF, GIF (e.g., animated or otherwise), and the like, or embodied in such vector-based file formats as Adobe® Flash, Adobe® Illustrator, and the like. Those skilled in the art will appreciate that other audio, video, or image effects can be embodied in other multimedia file formats that may or may not be applied to the foundational content as an overlay layer.

When a sprite effect or sprite sheet is stored on the sprite-based library datastore 212, sprite-based effects can be stored in their native multimedia file formats or, alternatively, converted to another multimedia format (e.g., to an audio and/or video file format common across datastore 212). As described herein, in operation, the sprite-based library datastore 212 can store a given sprite sheet by storing associations between the given sprite sheet and one or more sprite effects stored on the sprite-based library datastore 212.

In some implementations, the sprite-based content editor server 202 can include a licensing management engine that determines the licensing parameters (e.g., rights and permissions) of an effect, particularly those relating to sprite effects and sprite sheets stored on the sprite-based library datastore 212. The licensing management engine can also inform the sprite-based content editing engine 208 of such parameters. The sprite-based content editing engine 208, in turn, can adapt or control its own functionality in accordance with the licensing rights and permissions of the effect as it is applied to foundational content.

For example, where the licensing rights and permissions of a particular sprite sheet restricts sprite effects in the particular sprite sheet from being used with foundational content to be published on YouTube®, the sprite-based content editing engine 208 can automatically disable a publication options relating to YouTube® when said sprite effects are applied to the foundational content. Other content licensing rights and permissions can include publication limitations on the foundational content that results after application of the sprite effects, or limitations on use of sprite effects from a certain sprite sheet based on the content existing in the foundational content. A licensing management engine can inform the sprite-based content editing engine 208 of the cost of the sprite sheet or certain sprite effects associated therewith based on their use in accordance with the licensing rights and permissions. For certain implementations, the authors of the sprite effect or sprite sheet can configure the licensing rights and permissions for the same, which can then be stored on the sprite-based library datastore 212 and retrieved by a licensing management engine.

In the example of FIG. 2, the sprite-based content rendering engine 214 can render one or more layers of the foundational content, using a selected sprite effect from a sprite sheet provided by the sprite-based library engine 210 (from the sprite-based library datastore 212), after the selected sprite effect is applied to the foundational content by the sprite-based content editing engine 208. As a result of rendering operation(s), the sprite-based content rendering engine 214 can generate a rendered content product that is consumable by other users (e.g., via a stand-alone media player).

For example, the sprite-based content rendering engine 214 can generate the rendered content product to be in a media data format (e.g., QuickTime® movie [MOV], Windows® Media Video [WMV], or Audio Video Interleaved [AVI])) compatible with a standards-based media players and/or compatible with a streaming media service (e.g., YouTube®). As the sprite-based content rendering engine 214 renders layers of the foundational content to generate the rendered content product, the sprite-based content editing engine 208 can provide the sprite-based content rendering engine 214 with information specifying the effect(s) (e.g., sprite effects) presently applied to the foundational content, the desired quality (e.g., 480p, 780p, or 1080p video) or version for the resulting layers, and/or the desired media format of the rendered content product. As described herein, licensing parameters associated with the sprite effect or sprite sheet applied to the foundational content can determine rendering options (e.g., limitations) with respect to the foundational content.

Once generated, the sprite-based content rendering engine 214 can provide the rendered content product to the sprite-based content publication engine 216. In the example of FIG. 2, the sprite-based content publication engine 216 can receive a rendered content product from the sprite-based content rendering engine 214 and publishes the rendered content product for consumption by the others. For example, the rendered content product can be published such that the rendered content product can be downloaded and saved by the user or others as a stand-alone content file (e.g., MPEG or AVI file), or such that rendered content product can be shared to other over the network (e.g., posted to a website, such as YouTube® so that others can play/view the rendered content product). As described herein, one or more licensing parameters associated with an effect (e.g., sprite effect or sprite sheet) applied to the rendered content product can determine publication options (e.g., limitations) with respect to the rendered content product.

Once published, the rendered content product can be stored on the server-version content datastore 218. For some implementations, the published rendered content product can be added to a content library datastore (not shown) for reuse in other content products. Depending on the implementation, the published rendered content product can be added to a content library datastore as for-purchase content (for instance, via a content library/market place engine, with the sales proceeds being split between amongst the user and the content editor service provider), or added to the content library datastore as free content available to the public. The user can also define content usage parameters (i.e., licensing rights) for their rendered content product when the rendered content product is added to a content library datastore.

In the example of FIG. 2, the sprite-based content editor client 206 can comprise the content editor user interface engine 222 and a local-version content datastore 224 coupled to the content editor user interface engine 222. The content editor user interface engine 222 can facilitate application of effects, content creation, or content modification of foundational content at the sprite-based content editor server 202 by the sprite-based content editor client 206. As noted herein, the content editor user interface engine 222 can establish a connection with the sprite-based content editing engine 208 through the computer-readable medium 204, and then issue commands relating to application of effects, content creation, or content modification to the sprite-based content editing engine 208. In accordance with the issued commands, the sprite-based content editing engine 208 can perform the application of effects, content creation, or content modification operations at the sprite-based content editing engine 208, and can return to the content editor user interface engine 222 a version of the resulting foundational content (e.g., the foundational content).

Alternatively, the sprite-based content editor client 206 can apply an effect and modify content by receiving a copy of the latest version of the foundational content as stored at the sprite-based content editor server 202, applying a corresponding sprite effect to or modifying the received copy, and then uploading the modified copy to the sprite-based content editor server 202 so that the application of the effect and/or modifications can be applied to the last version of the foundational content stored at the sprite-based content editor server 202. When the modified copy is uploaded from the sprite-based content editor client 206 to the sprite-based content editor server 202 to facilitate application of effects and/or content modification of the foundational content, various implementations can utilize one or more methods for optimizing the network bandwidth usage.

In some implementations, where the sprite-based content editor server 202 is implemented using virtual or cloud-based computing resources, such virtual or cloud-based computer resources can be managed through the cloud management engine 220. The cloud management engine 220 can delegate various content-related operations and sub-operations of the server 202 to virtual or cloud-based computer resources, and manage the execution of the operations. Depending on the implementation, the cloud management engine 220 can facilitate management of the virtual or cloud-based computer resources through an application program interface (API) that provides management access and control to the virtual or cloud-based infrastructure providing the computing resources for the sprite-based content editor server 202.

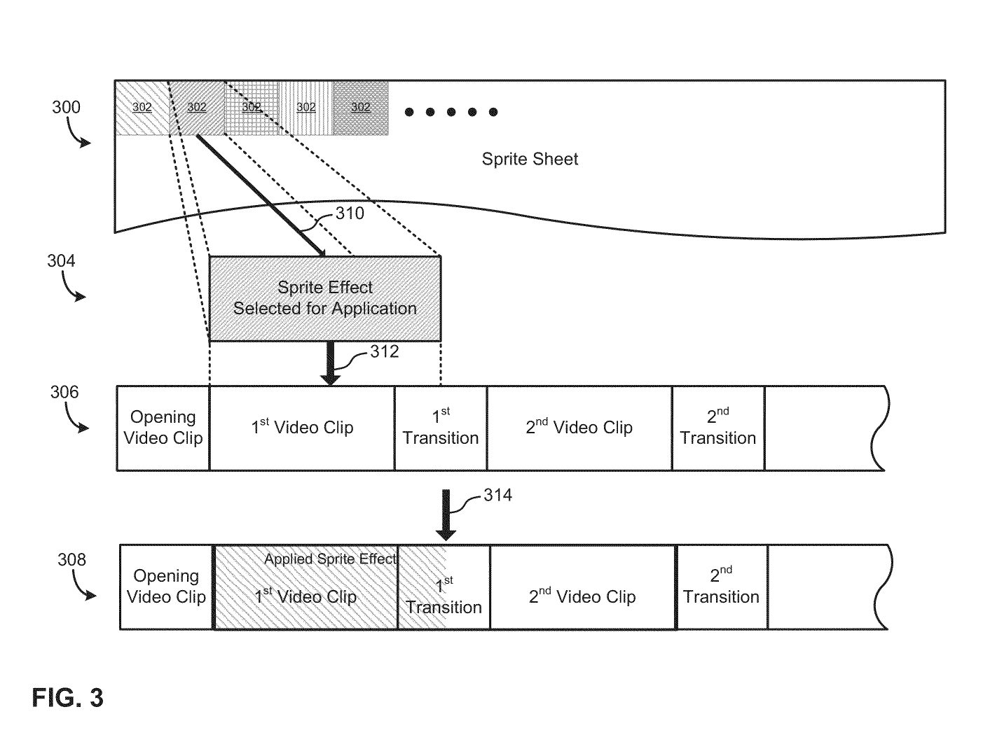

FIG. 3 depicts a diagram illustrating an example of a sprite sheet 300 and an example of applying of a selected sprite effect 304 to multimedia content in accordance with some implementations. In the example of FIG. 3, the sprite sheet 300 includes a plurality of sprites effects 302 available for application to foundational content, represented by content timeline 306. According to the content timeline 306 as shown, the foundational content can comprise an opening video clip at the start, a first video clip, a first transition (e.g., video or audio transition), a second video clip, a second transition, and possibly additional content portions. As shown, a selected sprite effect 304 is retrieved (310) from the sprite sheet 300, possibly based on the coordinates relative to the sprite sheet 300 (e.g., x and y coordinates). As also shown, the selected sprite effect 304 is applied (312) to the foundational content to result (314) in the foundational content represented by content timeline 308. The selected sprite effect 304 is applied

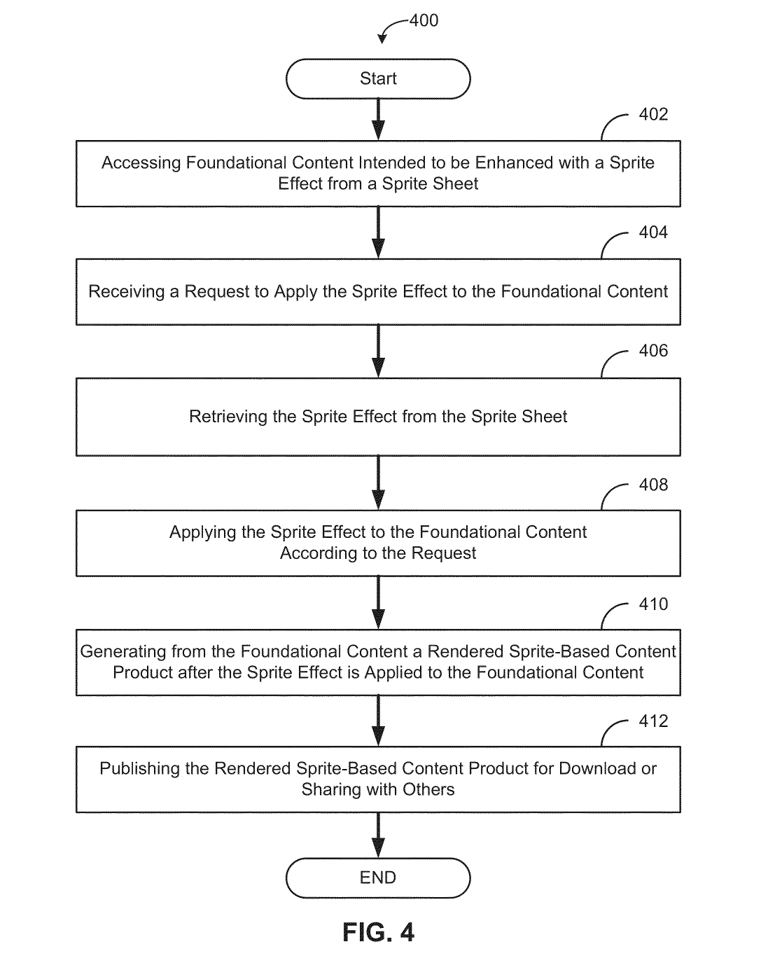

FIG. 4 depicts a flowchart 400 of an example of a method for sprite-based content editing in accordance with some implementations. In some implementations, the modules of the flowchart 400 and other flowcharts described in this paper are reordered to a permutation of the illustrated order of modules or reorganized for parallel execution. Those skilled in the art will appreciate that in some implementations, the modules of the flowchart 400 can be reordered to a permutation of the illustrated order of modules or reorganized for parallel execution.

Depending on the implementation, the example method depicted by flowchart 400 can be performed by a client, a server, or both. For instance, the method can be performed by a server that is applying effects, to foundational content, on behalf of (e.g., at the request of) a client. The server can receive a request to apply a set of client selected effects to the foundational content, retrieve one or more sprite sheets that include sprite effects corresponding to some or all of the client select effects, and apply the relevant sprite effects to the foundational content according to the request. In another instance, the method can be performed by a client to locally apply effects to a local version of foundational content, possibly to generate preview content that corresponds to foundational content being similarly enhanced, at a server, on behalf of the client.

In the example of FIG. 4, the flowchart 400 can start at module 402 with accessing foundational content that a user intends to enhance using a sprite effect from a sprite sheet. As discussed herein, where the method is being performed at a server, the foundational content can be located local to the server. In other implementations, where the method is being performed at a client, the client can receive the foundational content from a server and store it as a local version (e.g., local copy), which can subsequently acted upon, by the client, to locally generate preview content that corresponds (e.g., mirrors) content being generated at the server (e.g., from content modification operations).

In the example of FIG. 4, the flowchart 400 can continue to module 404 with receiving a request to apply the sprite effect to the foundational content. For example, where the method is being performed at a server, the request can be received from the client by a server that is performing effects-based modification and/or creation on behalf of the client. In other implementations, where the method is being performed at a client, an engine in the client would receive the request and proceed accordingly.

In the example of FIG. 4, the flowchart 400 can continue to module 406 with retrieving the sprite effect from the sprite sheet. As described herein, the desired sprite effect can be retrieved by retrieving, from a datastore, the relevant sprite sheet containing the desired sprite effect. In some implementations, the relevant sprite sheet can be generated by an engine managing the datastore, whereby the datastore stores one or more of the sprite effects individually and stores the sprite sheet as an association of sprite effects to the sprite sheet. In certain implementations, the sprite sheet can be pre-generated and stored in the datastore. Additionally, where the method is being performed at a client, the sprite sheet may be retrieved from (e.g., provided by) a server that is performing higher quality foundational content operations on behalf of the client.

In the example of FIG. 4, the flowchart 400 can continue to module 408 with applying the sprite effect to the foundational content according to the request. As described herein, a sprite sheet can include two or more sprites that retrievable from the sprit based on coordinates relative to the sprite sheet (e.g., X and Y Cartesian coordinates). Accordingly, for some implementations, the application of a sprite effect can comprise retrieving the desired sprite effect from the appropriate coordinates of the sprite sheet and then applying the sprite effect to the foundational content. The coordinates of specific sprite effects within the sprite sheet can be stored in the datastore providing the sprite sheet, possibly as part of the sprite sheet.

In the example of FIG. 4, the flowchart 400 can continue to module 410 with generating from the foundational content a rendered content product after the sprite effect is applied to the foundational content. Subsequently, the flowchart 400 can continue to module 412 with publishing the rendered content product for download or sharing with others. For some implementations, the publication of the rendered content product can enable the rendered content product to be consumable by another user. As described herein, the licensing parameters can determine publication options for the rendered content product.

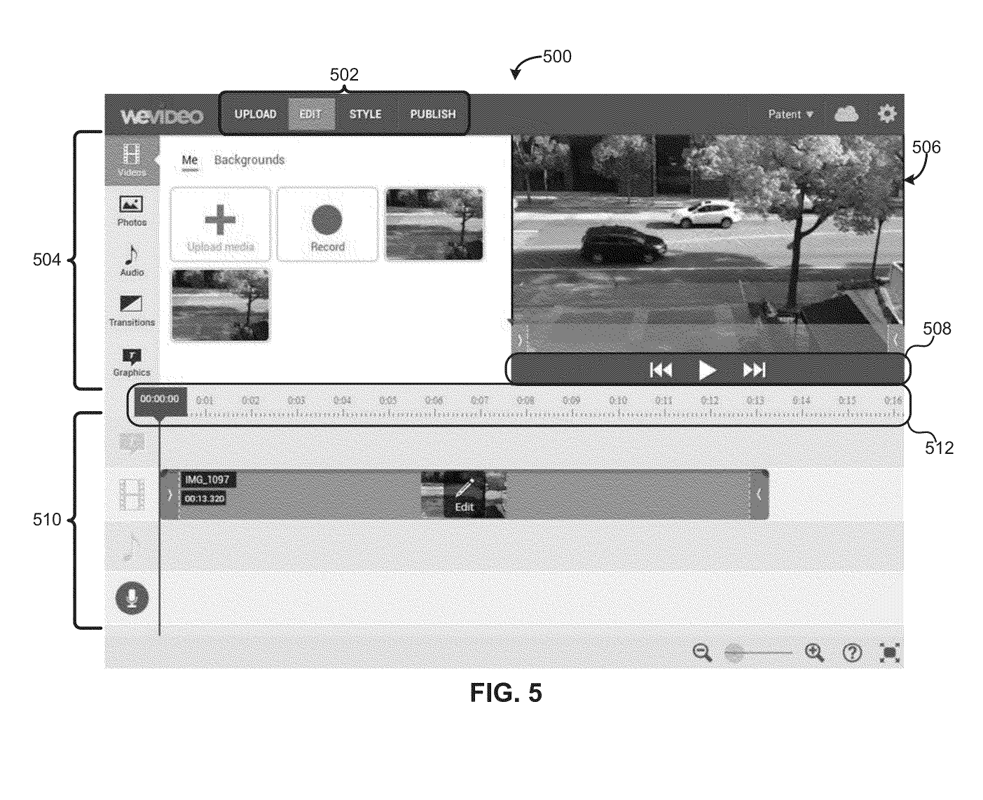

FIG. 5 depicts an example of a client-side user interface 500 for sprite-based content editing in accordance with some implementations. With respect to some implementations, the client-side user interface of FIG. 5 can control effect application (e.g., application of a sprite effect from a sprite sheet), content creation, or content editing operations performed on foundational content. In particular, the client-side user interface 500 can control a sprite-based content editing engine operating at a client, a sprite-based content editing engine operating at a server, or both to facilitate the effect application, content creation and content editing operations on the foundational content.

As described herein, for various implementations, the client-side user interface 500 can cause various engines to operate such that foundational content is enhanced by the server using an effect and the resulting foundational content is received by a client from the server. The client-side user interface 500 can also cause engines to operate such that a copy of the foundational content is enhanced or modified at the client using effects (e.g., a preview version is enhanced or modified at the client using a sprite effect). Subsequently, the client may or may not upload the enhanced/modified foundational content to the server (e.g., for updating the latest version of the foundational content and/or final rendering of the foundational content into a rendered content product).

Additionally or alternatively, the client-side user interface 500 can cause various engines to operate such that the foundational content is prepared and stored at a server on behalf of the client, the client instructs the server to perform effects-based enhancement/modification operations on the foundational content, and the client instructs the server (e.g., through the client-side user interface 500) to enhance/modify the foundational content the latest version of the foundational content at the server. The behavior and/or results of the client-side user interface 500 based on user input can be based on individual user preferences, administrative preferences, predetermined settings, or some combination thereof.

In some implementations, the client-side user interface 500 can be transferred from a server to a client as a module that can then be operated on the client. For instance, the client-side user interface 500 can comprise a client-side applet or script that is downloaded to the client from the server and then operated at the client (e.g., through a web browser). Additionally, the client-side user interface 500 can operate through a plug-in that is installed in a web browser. User input to the client-side user interface 500 can cause a command relating to online content editing, such as a content layer edit command or a content player/viewer command, to be performed at the client or to be transmitted from the client to the server.

The client-side user interface 500 can include multiple controls and other features that enable a user at a client to control the application of an effect (e.g., sprite effect), content creations, and content modification of foundational content. In the example of FIG. 5, the client-side user interface 500 includes a tabbed menu bar 502, a content listing 504, a content player/viewer 506, content player/viewer controls 508, a content layering interface 510, and a content timeline indicator 512.

As shown, the client-side user interface 500 can include the tabbed menu bar 502 that allows the user to select between: loading foundational content to a sprite-based content editing system (for subsequent sprite-based enhancement, content creation, or content modification); previewing and/or adding different content types (e.g., video, audio, or images/graphics available to them from a content library) to the foundational content, switching to content-creation/content-editing operations that can be performed on the foundational content; previewing and/or applying an effect to the foundational content. In the example of FIG. 5, the tabbed menu bar 502 presents a user with selecting between “Upload” (e.g., uploading personal content or effects), “Edit” (e.g., content editing mode, which presents the client-side user interface 500 as shown in FIG. 5), “Style” (e.g., applying styles to the foundational content through use of one or more effects), and “Publish” (e.g., publishing the latest version of the foundational content for consumption by others). The personal content can be that which the user uploaded to their account on the server, that which the user already created on the server, or both. Those of ordinary skill in the art would appreciate that in some implementation, the tabbed menu bar 502 can include one or more selections that correspond to other functionalities of a sprite-based content editing system.

In the example of FIG. 5, the content listing 504 can display a list of content available (e.g., from a content library) for use when editing the foundational. From the content listing 504, a user can add content to a new or existing content layer of the foundational content, possibly by “dragging-and-dropping” content items from the content listing 504 into the content layering interface 510. Examples of content types that can be the content listing 504 video, audio, images/graphics, transitions (e.g., audio or video), and the like. Depending on the implementation, transitions can include predefined (e.g., vendor provided) or user-created content transitions that can be inserted between two content items in a layer of the foundational content. For instance, with respect to video content (i.e., video clips), available transitions can include a left-to-right video transition which once inserted between a first video clip and a second video clip, can cause the first video clip transition to the second video clip in a left-to-right manner. Similarly, with respect to audio content (i.e., audio clips), available transitions can include a right-to-left transition which once inserted between a first audio clip and a second audio clip, can cause the first audio clip to fade into to the second audio clip starting from the right audio channel and ending at the left audio channel.

In some implementations, the content listing 504 can list the available content with a thumbnail image configured to provide the user with a preview of the content. For example, for a video content item, the thumbnail image may be a moving image that provides a brief preview of the video content item before it is added to the foundational content. With respect to an image content item, the thumbnail preview may be a smaller-sized version (i.e., lower resolution version) of the image content item. In certain implementations, a content item listed in content listing 506 can be further previewed in the content player/viewer 506, which may or may not be configured to play audio, play video, play animations, and/or display images (e.g., in a larger resolution than the thumbnail preview). The content listing 504 can also provide details regarding the listed content where applicable, including, for example, a source of the content, a date of creation for the content, a data size of the content, a time duration of the content, licensing information relating to the content item (where, and cost of using the content item.

In certain implementations, the user can graphically modify a temporal position or duration of a content layer or a content item within the content layer. For example, the user can “drag-and-drop” the graphically represented start or end of a content item (e.g., a cue) to adjust the duration of the content item (thereby the temporal start of temporal end of the content item) in the collaborative content product. According to various implementations, when a temporal position, duration, or other temporal characteristic, associated with a content layer or a content item of the foundational item, is adjusted, corresponding adjustments can be automatically performed to any effect that is presently applied to the foundational content. As such, for some implementations, content modification can be performed on the foundational content even after an effect has been applied, while the impact of the effect is maintained.

In the example of FIG. 5, a user can utilize the content player/viewer 506 to preview content items (e.g., videos, photos, audio, transitions, or graphics) listed in the content listing 504 and available for use when creating or modifying content in the foundational content. The content player/viewer 506 can also provide a preview of the foundational content that is being enhanced, created or modified through the client-side user interface 500. Depending on the implementation, the version of the foundational content that can be previewed through the client-side user interface 500 can be the latest version stored at the server, at the client, or both.

In one example, the user can applying an effect to the foundational content that the user intends to enhance then preview the resulting sprite-based foundational content through the content player/viewer 506. Depending on the implementation, the content being previewed can be from a latest version of the foundational content residing at the server, a rendered version of the foundational content residing at the server, or a latest version of foundational content locally residing at the client. Where content being played or shown is provided from the server, such content can be streamed from the server to the client as the content is played or shown through the content player/viewer 506. In some implementations, where content being played or shown is provided from the server, such content can be first downloaded to the client before it is played or shown through the content player/viewer 506.

In the example of FIG. 5, a user can control the operations of the content player/viewer 506 using the content player/viewer controls 508. The content player/viewer controls 508 can include control commands common to various players, such as previous track, next track, fast-backward, fast-forward, play, pause, and stop. In some implementations, a user input to the content player/viewer controls 508 can result in a content player/viewer command instruction being transmitted from the client to the server, and the server providing and/or streaming the content to the client to facilitate playback/viewing of selected content.

In the example of FIG. 5, the content layering interface 510 can enable a user to access and modify content layers of the foundational content. The content layering interface 510 can comprise a stack of content layer slots, where each content layer slot can graphically present all the content layers of a particular content type associated to the collaborative content product, or can present each content layer is a separate slot. Example content types include, without limitation, graphical content (e.g., “Graphics”), video content (e.g., “Video”), image content (e.g., “Image”), and audio content (e.g., “Audio”). Additionally, for particular implementations, when an effect is applied to the foundational content, the applied effect can be graphically presented in a separate layer slot in the content layering interface 510. The content layering interface 510 as shown in FIG. 5 comprises a content layer slot for graphical content, video content, soundtrack content, and audio recording content.

The content layering interface 510 can also comprise controls or features that enable the user to edit content layers of the foundational content. Through the content layering interface 510, a user can implement edits to a content layers, or content items thereof, particularly with respect to timelines and/or temporal elements associated with the content layer or content item (e.g., temporal position or duration of a content item). Generally, the content layering interface 510 can display timelines and/or temporal elements relating to an effect once it has been applied to the foundational content. Temporal elements/cues, such as content starts, stops, and the like, can be represented in content layers as time markers. In some instances, a time marker for a given cue can be shown according to what the cue represents (e.g., temporal start, stop, or pause), the time value the cue represents, the timeline associated with the cue, or the effect to which the cue is associated. Positioning of the time marker in the content layering interface 510 can be relative the content timeline indicator 512. For some implementations, adjustments to the cues can be facilitated (by a user) through use of time markers in the content layering interface 510 (e.g., “drag-and-drop” actions in connection with the time markers). The content layering interface 510 can include edit controls that enable a user to add, delete or modify one or more content layers of the foundational content. Example edit controls include adding a content layer, deleting a content layer, splitting a single content layer into two or more content layers, editing properties of a content layer, and the like.

In the example of FIG. 5, the content timeline indicator 512 can visually assist a user in determining a temporal position of a content layer or content item, or cue in the foundational content. For instance, the content timeline indicator 512 can comprise a time marker representing a cue, such as a temporal start point or a temporal end point for a content layer or a content item in the content layer. In certain implementations, the length of the content timeline indicator 512 can adapt according to the overall duration of the collaboratively-created creation, or can be adjusted according to a user-setting.

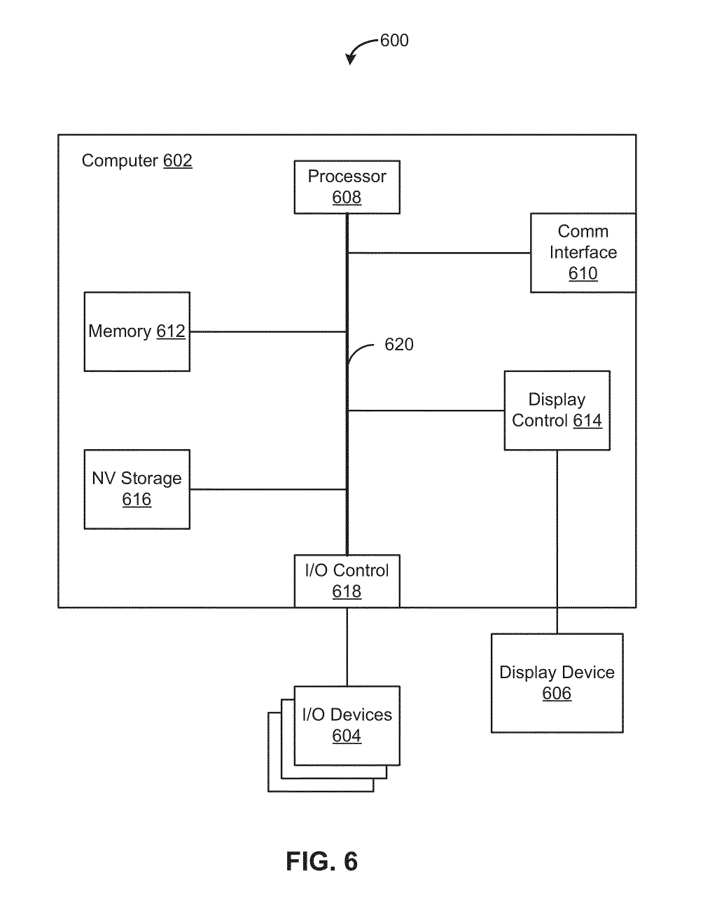

FIG. 6 shows an example of a system on which techniques described in this paper can be implemented. The computer system 600 can be a conventional computer system that can be used as a client computer system, such as a wireless client or a workstation, or a server computer system. The computer system 600 includes a computer 602, I/O devices 604, and a display device 606. The computer 602 includes a processor 608, a communications interface 610, memory 612, display controller 614, non-volatile storage 616, and I/O controller 618. The computer 602 may be coupled to or include the I/O devices 604 and display device 606.

The computer 602 interfaces to external systems through the communications interface 610, which may include a modem or network interface. It will be appreciated that the communications interface 610 can be considered to be part of the computer system 600 or a part of the computer 602. The communications interface 610 can be an analog modem, ISDN modem, cable modem, token ring interface, satellite transmission interface (e.g. “direct PC”), or other interfaces for coupling a computer system to other computer systems.

The processor 608 may be, for example, a conventional microprocessor such as an Intel Pentium microprocessor or Motorola power PC microprocessor. The memory 612 is coupled to the processor 608 by a bus 620. The memory 612 can be Dynamic Random Access Memory (DRAM) and can also include Static RAM (SRAM). The bus 620 couples the processor 608 to the memory 612, also to the non-volatile storage 616, to the display controller 614, and to the I/O controller 618.

The I/O devices 604 can include a keyboard, disk drives, printers, a scanner, and other input and output devices, including a mouse or other pointing device. The display controller 614 may control in the conventional manner a display on the display device 606, which can be, for example, a cathode ray tube (CRT) or liquid crystal display (LCD). The display controller 614 and the I/O controller 618 can be implemented with conventional well known technology.

The non-volatile storage 616 is often a magnetic hard disk, an optical disk, or another form of storage for large amounts of data. Some of this data is often written, by a direct memory access process, into memory 612 during execution of software in the computer 602. One of skill in the art will immediately recognize that the terms “machine-readable medium” or “computer-readable medium” includes any type of storage device that is accessible by the processor 608 and also encompasses a carrier wave that encodes a data signal.

The computer system 600 is one example of many possible computer systems which have different architectures. For example, personal computers based on an Intel microprocessor often have multiple buses, one of which can be an I/O bus for the peripherals and one that directly connects the processor 608 and the memory 612 (often referred to as a memory bus). The buses are connected together through bridge components that perform any necessary translation due to differing bus protocols.

Network computers are another type of computer system that can be used in conjunction with the teachings provided herein. Network computers do not usually include a hard disk or other mass storage, and the executable programs are loaded from a network connection into the memory 612 for execution by the processor 608. A Web TV system, which is known in the art, is also considered to be a computer system, but it may lack some of the features shown in FIG. 6, such as certain input or output devices. A typical computer system will usually include at least a processor, memory, and a bus coupling the memory to the processor.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Techniques described in this paper relate to apparatus for performing the operations. The apparatus can be specially constructed for the required purposes, or it can comprise a general purpose computer selectively activated or reconfigured by a computer program stored in the computer. Such a computer program may be stored in a computer-readable storage medium, such as, but is not limited to, read-only memories (ROMs), random access memories (RAMs), EPROMs, EEPROMs, magnetic or optical cards, any type of disk including floppy disks, optical disks, CD-ROMs, and magnetic-optical disks, or any type of media suitable for storing electronic instructions, and each coupled to a computer system bus.

As disclosed in this paper, implementations allow editors to create professional productions using effects (e.g., sprite effects from sprite sheets) and based on a wide variety of amateur and professional content gathered from numerous sources. Although the foregoing implementations have been described in some detail for purposes of clarity of understanding, implementations are not necessarily limited to the details provided.

We claim:

1. A system, comprising:
a sprite-based content editing engine;
a sprite-based effects library engine coupled to the sprite-based content editing engine;
a sprite-based effects library datastore coupled to the sprite-based effects library engine, wherein the sprite-based effects library datastore comprises a sprite sheet that includes at least one sprite effect, the sprite effect configured to be applied to content;
wherein, in operation:
the sprite-based content editing engine receives a request to apply the sprite effect to foundational content being accessed by the sprite-based content editing engine;
the sprite-based effects library engine provides the sprite-based content editing engine, from the sprite-based effect library datastore, the sprite sheet;
the sprite-based content editing engine retrieves the sprite effect from the sprite sheet;
the sprite-based content editing engine applies the sprite effect to the foundational content according to the request.

2. The system of claim 1, wherein the sprite-based content editing engine receives the request from a client over a network.

3. The system of claim 1, wherein the sprite-based content editing engine provides the sprite sheet to a client as a client-side sprite sheet, the client being configured to apply a client-side sprite effect from the client-side sprite sheet to client-side content, the client-side sprite effect corresponding to the sprite effect, the client-side content corresponding to the foundational content.

4. The system of claim 3, wherein the client applies the client-side sprite effect to the client-side content to generate, at the client, a preview of the foundational content that results from application of the sprite effect by the sprite-based content editing engine.

5. The system of claim 1, wherein the sprite sheet comprises at least two sprite effects each of which is retrievable from the sprite sheet using coordinates in the sprite sheet.

6. The system of claim 1, wherein the sprite effect comprises an image or an animation.

7. The system of claim 1, further comprising a sprite-based content rendering engine, wherein, in operation, the sprite-based content render engine generates from the foundational content a rendered content product after at least the sprite effect from the sprite sheet is applied to the foundational content, the rendered content product being a format consumable by another user.

8. The system of claim 7, wherein the sprite-based content render engine generates the rendered content product using a higher-quality sprite effect than the sprite effect, the higher-quality sprite effect corresponding to the sprite effect.

9. The system of claim 7, further comprising a content publication engine, wherein, in operation, wherein, in operation, the content publication engine publishes the rendered content product for consumption by another user.

10. A method, comprising:
accessing, at a computer system, foundational content to which a user intends to apply a sprite effect from a sprite sheet;
receiving a request to apply the sprite effect to the foundational content;
retrieving the sprite effect from the sprite sheet;
applying the sprite effect to the foundational content according to the request.

11. The method of claim 10, further comprising receiving the sprite sheet.

12. The method of claim 10, wherein the computer system is a server and the request is received, at the computer system, from a client over a network.

13. The method of claim 10, further comprising providing the sprite sheet to a client as a client-side sprite sheet, the client being configured to apply a client-side sprite effect from the client-side sprite sheet to client-side content, the client-side sprite effect corresponding to the sprite effect, the client-side content corresponding to the foundational content.

14. The method of claim 13, wherein the client applies the client-side sprite effect to the client-side content to generate, at the client, a preview of the foundational content that results from application of the sprite effect by the sprite-based content editing engine.

15. The method of claim 10, wherein the sprite sheet comprises at least two sprite effects each of which is retrievable from the sprite sheet using coordinates in the sprite sheet.

16. The method of claim 10, wherein the sprite effect comprises an image or an animation.

17. The method of claim 10, further comprising generating from the foundational content a rendered content product after at least the sprite effect from the sprite sheet is applied to the foundational content, the rendered content product being a format consumable by another user.

18. The method of claim 17, wherein the rendered content product is generated using a higher-quality sprite effect than the sprite effect, the higher-quality sprite effect corresponding to the sprite effect.

19. The method of claim 17, further comprising publishing the rendered content product for consumption by another user.

20. A system comprising:
means for accessing, at a computer system, foundational content to which a user intends to apply a sprite effect from a sprite sheet;
means for receiving a request to apply the sprite effect to the foundational content;
means for retrieving the sprite effect from the sprite sheet;
means for applying the sprite effect to the foundational content according to the request.
